(19) United States
(12) Patent Application Publication
(10) Pub. No.: US 2025/0328757 A1
(43) Pub. Date: Oct. 23, 2025

(54) TECHNIQUES FOR IMPROVED LENGTH CONSTRAINT COMPLIANCE

(71) Applicant: GOOGLE LLC, Mountain View, CA (US)

(72) Inventors: Wael Farhan, Kirkland, WA (US); Zizhao Zhang, Santa Clara, CA (US); Jin Miao, San Jose, CA (US); Jay Pavagadhi, Santa Clara, CA (US); Le Hou, Sunnyvale, CA (US); Siddhartha Brahma, San Jose, CA (US); Simon Tokumine, San Francisco, CA (US); Tom Kwiatkowski, New York, NY (US)

(21) Appl. No.: 18/643,548

(22) Filed: Apr. 23, 2024

(51) Int. Cl. G06N 3/08; G06N 3/045

(52) U.S. Cl. CPC G06N 3/08; G06N 3/045

(57) ABSTRACT

Implementations are described herein for improving compliance with length constraints imposed on generative model output. In various implementations, a candidate generative model training example may be retrieved and include an input prompt and a generative model response that was generated by processing the input prompt using one or more generative models. The input prompt may be analyzed to identify length constraint(s) intended to be imposed on the generative model response. The generative model response may be evaluated for compliance with the length constraint(s). Based on a determination that the generative model response fails to comply with one or more of the length constraints, the candidate generative model training example may be modified to generate a synthetic generative model training example for which one or more length constraints are satisfied. The generative model(s) may be trained using the synthetic generative model training example.

### BACKGROUND

Generative models such as large language models (LLMs) may be trained using a variety of techniques to perform a variety of tasks. Generative models are not conventionally trained as counting machines, and therefore struggle with generating output having a specific length in terms of words, sentences, paragraphs, etc.

### SUMMARY

Implementations are described herein for improving the abilities of generative models to generate output that satisfies length constraints. More particularly, but not exclusively, techniques described herein relate to evaluating pairs (or more generally, tuples) of generative model prompts and responses for compliance with length constraint(s), and generating synthetic training data that is usable to train and/or fine-tune generative models such as LLMs for improved compliance with length constraint(s).

In various implementations, a method may be implemented using one or more processors and may include: retrieving a candidate generative model training example, wherein the candidate training example includes an input prompt and a generative model response that was generated by processing the input prompt using one or more generative models; analyzing the input prompt to identify one or more length constraints intended to be imposed on the generative model response; evaluating the generative model response for compliance with one or more of the length constraints; based on a determination that the generative model response fails to comply with one or more of the length constraints, modifying the candidate training example to generate a synthetic generative model training example for which one or more length constraints are satisfied; and training one or more of the generative models using the synthetic generative model training example.

In various implementations, the modifying may include altering one or more of the length constraints of the input prompt to match one or more length features of the generative model response. In various implementations, the match may include a fuzzy match. In various implementations, the modifying may include altering the generative model response to match (exact or fuzzy) one or more of the length constraints. In various implementations, the altering may include processing the input prompt using one or more of the generative models to generate a new generative model response.

In various implementations, analyzing the input prompt may include parsing the input prompt to detect one or more linguistic concepts and numeric modifiers of the one or more linguistic concepts. In various implementations, the one or more linguistic concepts may include a sentence, and the one or more numeric modifiers may include a number of requested sentences. In various implementations, the one or more linguistic concepts may include a word, and the one or more numeric modifiers may include a number of requested words. In various implementations, the one or more linguistic concepts may include a paragraph, and the one or more numeric modifiers may include a number of requested paragraphs.

In various implementations, analyzing the input prompt may include performing natural language processing (NLP) on the input prompt to identify an intent behind the prompt and one or more parameters of the intent. One or more of the parameters of the intent may include one or more of the length constraints. In various implementations, analyzing the input prompt may include: assembling data indicative of the input prompt into an auxiliary input prompt; assembling, into the auxiliary prompt, data indicative of a natural language request to identify the one or more length constraints in the input prompt; and processing the auxiliary input prompt using one or more of the generative models to generate auxiliary generative model output indicative of one or more of the length constraints. In various implementations, one or more of the generative models may be a large language model (LLM).

In another aspect, a method may be implemented using one or more processors and may include: retrieving a generative model interaction set that includes an input prompt and two or more candidate generative model responses that were generated by processing the input prompt using one or more generative models; analyzing the input prompt to identify one or more length constraints intended to be imposed on the generative model responses; evaluating the candidate generative model responses for compliance with one or more of the length constraints; based on the evaluating, selecting, for inclusion in a generative model training example, the input prompt and the candidate generative model response that most closely complies with one or more of the length constraints; and training one or more of the generative models using the generative model training example.

In various implementations, the two or more candidate generative model responses may include first and second candidate generative model responses, generated using the same generative model, which are different from each other. In various implementations, the first and second candidate generative model responses may differ from each other due to a temperature parameter used in association with the generative model. In various implementations, the two or more candidate generative model responses may include a first candidate generative model response generated using a first generative model and a second candidate generative model response generated using a second generative model that is different from the first generative model. In various implementations, the second generative model may include fewer parameters than the first generative model. In various implementations, the selecting may be performed using a trained reward function.

Other implementations may include a non-transitory computer readable storage medium storing instructions executable by a processor to perform a method such as one or more of the methods described above. Yet another implementation may include a control system including memory and one or more processors operable to execute instructions, stored in the memory, to implement one or more modules or engines that, alone or collectively, perform a method such as one or more of the methods described above.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 schematically depicts an example environment in which disclosed techniques may be employed, in accordance with various implementations.

FIG. 2 schematically depicts an example of how techniques described herein may be implemented, in accordance with various implementations.

FIG. 3 schematically depicts another example of how techniques described herein may be implemented, in accordance with various implementations.

FIG. 4 schematically depicts a flowchart demonstrating an example of how techniques described herein may be carried out.

FIG. 5 schematically depicts a flowchart demonstrating an example of how techniques described herein may be carried out.

FIG. 6 schematically depicts an example architecture of a computer system.

### DETAILED DESCRIPTION

Implementations are described herein for improving the abilities of generative models to generate output that satisfies length constraints. More particularly, but not exclusively, techniques described herein relate to evaluating pairs (or more generally, tuples) of generative model prompts and responses for compliance with length constraint(s), and generating synthetic training data that is usable to train and/or fine-tune generative models such as LLMs for improved compliance with length constraint(s).

In some implementations, existing pairs of generative model prompts and corresponding responses may be obtained, e.g., from logs generated in association with the use of generative models. In a first aspect of the present disclosure, these existing pairs of generative model prompts and corresponding prompts may be evaluated as candidate generative model training examples, in particular for whether they are suitable to improve a generative model's capability of predicting output that satisfies length constraint(s) provided, for instance, as part of input prompts.

Not every input prompt will specify length constraints. Accordingly, one aspect of evaluating candidate generative model training examples may include filtering out candidate generative model training examples that lack any length constraints. Even when input prompts specify length constraints, those constraints may not be satisfied by the resulting generative model output. Accordingly, another aspect of evaluating candidate generative model training examples many include filtering out those examples having input prompts with length constraints that are not satisfied by corresponding generative model responses. However, in yet other implementations, rather than non-compliant candidate generative model training examples being filtered out, they may instead be leveraged to generate synthetic generative model training examples that may be better suited for improving the abilities of generative models to generate output that satisfies length constraints.

Length constraints may be expressed in various ways, such as “in three sentences,” “using 150 words,” “in two paragraphs,” “using four bullet points,” “in a table having four rows,” in a table having two columns,” “using a table having three rows and three columns,” “with a three-by-four table,” etc. Various techniques may be used to detect length constraints in input prompts. In some implementations, length constraints may be detected programmatically and/or heuristically. For instance, an input prompt may be parsed to detect one or more linguistic concepts (e.g., identified by keywords), such as words, sentences, paragraphs, characters, stanzas, etc. The input prompt may also be parsed to detect numeric modifiers of the one or more linguistic concepts. For example, an input prompt of “summarize {{article}} in three paragraphs” may be parsed to detect (i) the linguistic concept of “paragraph” and (ii) the numeric modifier of “three.” These elements combine to form a length constraint of “three paragraphs” that is supposed to be imposed on generative model output that results from the input prompt.

Other techniques may be used, alone or in combination with programmatic logic and/or heuristics, to detect length constraints in input prompts. In some implementations, natural language processing (NLP) may be performed on the input prompt to identify an intent behind the input prompt—e.g., “summarize this article”—and one or more parameters of the intent. These parameters may include, for instance, length constraint(s) such as those described previously.

In other implementations, machine learning and/or generative artificial intelligence may be leveraged to detect length constraints in input prompts. For instance, data indicative of an input prompt, such as tokens, embeddings, etc., may be assembled into what will be referred to herein as an “auxiliary input prompt.” Additionally, data indicative of a request (e.g., expressed in natural language) to identify the one or more length constraints in the input prompt may be assembled into the auxiliary input prompt. In many cases, this request may be implicit, e.g., provided automatically as part of a workflow, rather than being explicitly provided by a user. The auxiliary input prompt may be processed using the same generative model as will be used downstream to process the original input prompt, or a different machine learning model trained expressly for the purpose of detecting length constraints. Either way, the result may be the generation of auxiliary generative model output (or more generally, “auxiliary machine learning model output”) indicative of length constraint(s).

As noted previously, if no length constraints are detected in an input prompt of a candidate generative model training example, in some implementations, the candidate generative model training may be discarded. In other implementations, the candidate generative model training example may be modified (alternatively referred to as “hardened”) to generate a synthetic generative model training example for which length constraint(s) are satisfied. This may include, for instance, modifying the input prompt itself, e.g., by adding one or more synthetic length constraints that “match” (e.g., exact match, fuzzy match, fall within a range of each other, etc.) length features of the corresponding generative model response.

If length constraint(s) are detected in an input prompt of a candidate generative model training example, then the corresponding generative model response may be evaluated to determine whether its length features comply with the detected length constraint(s). For example, the generative model response may be parsed to detect length features such as counts of words, sentences, paragraphs, and/or other elements such as bullet points, characters, etc. These length features may then be compared to the detected length constraint(s) to determine compliance, e.g., via precise matching, fuzzy matching, matching within a range, etc.

If it is determined that length feature(s) of a generative model response of a candidate generative model training example fail to comply with detected length constraint(s) of a corresponding input prompt, then various actions may be taken. In some implementations, one or more length constraints of the input prompt may be altered to match one or more detected length features of the generative model response. For example, if an input prompt included a length constraint of forty words and a corresponding generative model response includes fifty-five words, then the length constraint of the input prompt may be replaced with a “forty word” length constraint. Alternatively, if the input prompt called for fifteen words and the corresponding generative model response included thirty words, the generative model response may be rewritten to fifteen words, or at least as close to fifteen words as possible while maintaining grammatically correctness and/or some threshold measure of quality.

In addition to modifying existing candidate generative model training examples to generate synthetic candidate generative model training examples, in some implementations, entirely new synthetic generative model training examples may be generated. For instance, a given input prompt for which a generative model response has already been generated may be processed again using the same generative model or a different generative model to generate a new/alternative generative model response having its own length feature(s). If the same generative model is used, then different sampling techniques and/or parameters such as temperature may be used to ensure the new/alternative generative model response differs from the original. Then, one or more length constraints may be added to the input prompt to align with the length feature(s) of the new/alternative generative model response. Or, if the input prompt already includes length constraint(s), they may be modified to align with length feature(s) of the new/alternative generative model response. In this way, it is possible to generate large amounts of training data automatically.

In some implementations, techniques such as reinforcement learning may be employed to automatically generate/curate training data that can then be used to train a generative model to better formulate its output in accordance with length constraints. For example, a given input prompt that includes one or more length constraints may be processed multiple times to generate multiple different candidate generative model responses. In some implementations, the same generative model may be used to generate each candidate generative model response, e.g., by selecting temperatures that ensure each response will be different. Additionally or alternatively, different generative models may be used, e.g., one “larger model” having more parameters than another “smaller” model. However they are generated, each candidate generative model response may then be evaluated, e.g., as described above and/or using a reward model trained specifically for such a purpose, for compliance with the input prompt's length constraint(s). The candidate generative model response that most closely aligns with the length constraint(s) may be selected for use as a training example to train/fine-tune the generative model. In some cases, at least one of the responses may be generated using the same generative model that will ultimately be trained. This may facilitate better alignment between the two different models, and ultimately, more tightly controlled generative model output.

In some implementations where the candidate generative model responses are generated using larger and smaller generative models, the larger generative model may be used as a “teacher” and the smaller generative model may be trained as a “student.” For instance, the smaller generative model may be trained using training data that is generated by the larger generative model. The smaller generative model may then be used subsequently to generate generative model output that is more closely aligned with length constraint(s) specified in input prompts, while requiring less computational resources than the larger generative model.

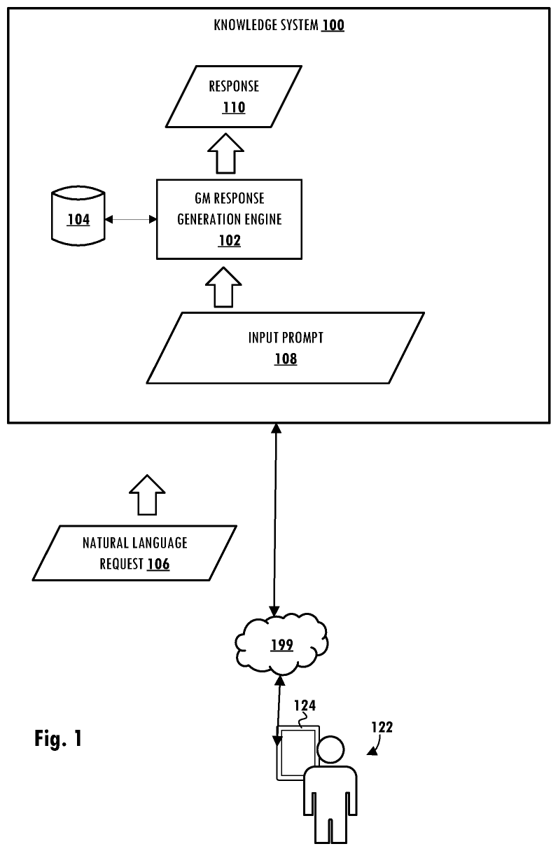

FIG. 1 is a schematic diagram illustrating components that can cooperate to carry out selected aspects of the present disclosure, in accordance with various implementations. The various components depicted in FIG. 1, particularly those components forming a knowledge system 100, may be implemented using any combination of hardware and software. The components of FIG. 1 are depicted as being communicatively coupled with each other via one or more networks 199, which may include one or more personal area networks, local area networks, and/or wide area networks (e.g., the Internet). However, this is not meant to be limiting. Various aspects of the present disclosure that are described as being performed by and/or stored on system 100 can alternatively be performed by and/or stored elsewhere and/or distributed across multiple systems, such as between system 100 and a client device 124.

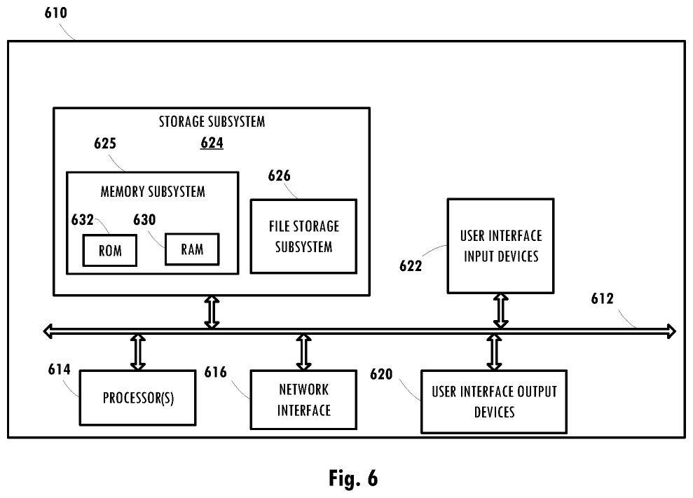

In some implementations, knowledge system 100 may include one or more computing devices cooperating to perform selected aspects of the present disclosure. An example of such a computing device is depicted schematically in FIG. 6. In some implementations, knowledge system 100 may include one or more servers forming part of what is often referred to as a “cloud” infrastructure, or simply “the cloud.” Alternatively, one or more components of system 100 may be operated by client device 124.

Knowledge system 100 may include a generative model (GM) response generation engine 102 communicatively coupled with one or more generative models 104. In various implementations, a user 122 may interact with knowledge system 100 using client device 124. While depicted as a tablet computer or smart phone in FIG. 1, client device 124 may take other forms, such as a desktop or laptop computer, in-vehicle computing device, augmented reality (AR) and/or virtual reality (VR) headset or glasses, standalone “smart” speakers that host automated assistants that can be interacted with the control robot 100, etc.

While shown as separate systems that communicate using network(s) 199, this is not meant to be limiting. Aspects of knowledge system 100 may be implemented in whole or in part on client device 124. If client device 124 includes sufficient computing resources, and/or generative model(s) it uses can be made sufficiently “lean,” it may be desirable to implement techniques described herein locally on client device 124 to avoid latency introduced by a round trip across network(s) 199.

User 122 may operate client device 124 to interact with knowledge system 100 by providing a natural language request 106 to knowledge system 100. Natural language request 106 may in some cases be a textual snippet that is typed by user 122 or spoken and transcribed using speech-to-text (STT) processing. STT processing may be implemented on client device 124 and/or knowledge system 100. In various implementations, data indicative natural language request 106 may be processed by knowledge system 100 as all or part of an input prompt 108.

In some cases, input prompt 108 may include the text of natural language request 106 by itself. In other cases, input prompt 108 may include additional text and/or other data such as embedding(s). This other data may include, for instance, data about a context of user 122, one or more sensor signals generated by client device 124 (e.g., position coordinates, time-of-day, gyroscope and/or accelerometer signals, etc.). While examples described herein relate to processing natural language requests in textual form, this is not intended to be limiting. In various implementations, techniques described herein may additionally or alternatively be used to process other modalities of data (e.g., images, audio streams, videos, etc.), including multiple different modalities at once.

GM response generation engine 102 may be configured to process input prompt 108 and/or data indicative thereof (e.g., embedding(s)) using one or more generative models 104 to generate a response 110. Response 110 may take the form of a textual response, and/or may include other modalities of data, such as images, videos, audio, etc. In various implementations, data indicative of response 110 may be returned to client device 124 and rendered as output to user 122.

In some cases, user 122 may wish to control various aspects of response 110, such as its length. For instance, user 122 may include, in natural language request 106, one or more length constraints. Length constraints may take various forms, depending on the type of output user 122 seeks. For instance, if user 122 requests textual output, then user 122 may also request length constraints on linguistic concepts such as number of characters, words, symbols, sentences, paragraphs, stanzas, etc. If user 122 requests textual output that includes visual formatting elements such as bullet points, tables, drop-down menus, graphs, flowcharts, etc., then the length constraints may include, for instance, number of bullet points, number of rows, number of columns, number of flowchart elements, or any combination thereof.

As noted previously, while generative model(s) 104 may be adept at generating accurate and/or useful responses, they may not necessarily be adept at generating responses that are constrained as requested by users. Accordingly, techniques described herein may be used to gather, collate, generate, and/or synthesize training data that can then be used to train and/or fine-tune generative model(s) 104 to be more responsive to requested length constraints.

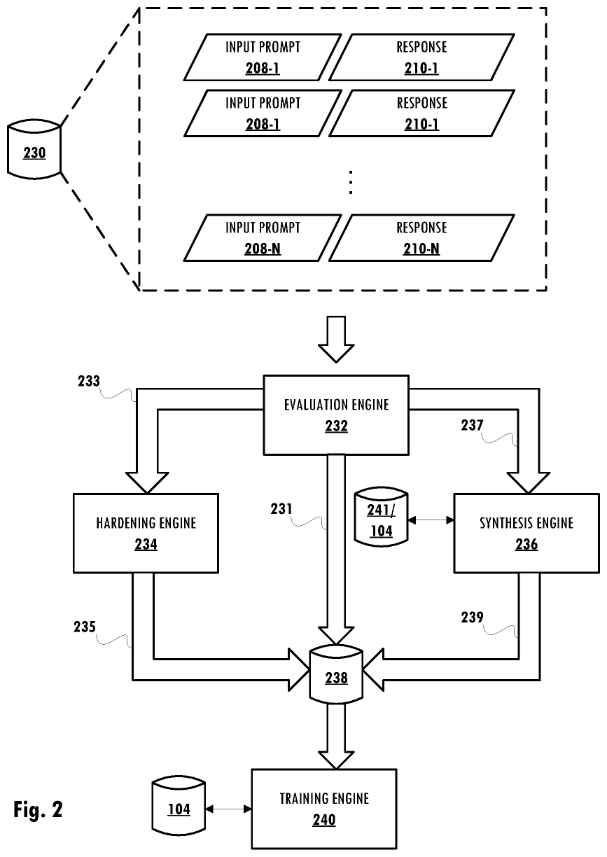

FIG. 2 schematically depicts an example of how a log 230 of input prompts 208-1 to 208-N and corresponding generative model responses 210-1 to 210-N (each pair forming a “candidate training example”) may be leveraged to generate curated training data 238. Curated training data 238 can then be used to train and/or fine-tune generative model(s) 104 to better conform generative model responses (e.g., 110) to requested length constraints. FIG. 2 also depicts various components that may take part in this process. These components may include an evaluation engine 232, a data hardening engine 234, and a synthesis engine 236 operably coupled with one or more synthesis generative models 241. Elements 232, 234, 236, and/or 241 may be implemented as part of knowledge system 100 or elsewhere. In other implementations, in addition to or instead of input prompts 208-1 to 208-N, techniques described herein may operate on raw natural language requests (e.g., 106).

Starting at top, evaluation engine 232 may be configured to retrieve candidate generative model training examples from log 230. Each candidate training example may include an input prompt 208 and a corresponding generative model response 210 that was generated by processing the input prompt 208 using generative model(s) 104. Evaluation engine 232 may analyze the input prompt 208 to identify one or more length constraints intended to be imposed on the generative model response.

Evaluation engine 232 may identify length constraints in various ways. In some implementations, evaluation engine 232 may use various heuristics and/or programmatic logic to identify length constraint(s). For instance, evaluation engine 232 may parse the input prompt 208 to detect one or more linguistic concepts and numeric modifiers of the one or more linguistic concepts. These linguistic concepts may include, for instance, sentences, words, characters, paragraphs, etc., and the numeric modifiers may include, for instance, a number of requested sentences, words, characters, paragraphs, etc.

Additionally or alternatively, in some implementations, evaluation engine 232 may be configured to perform natural language processing (NLP) and/or NL understanding on the input prompt 208—similar to the processing often performed by “virtual assistants” or chatbots to respond to natural language requests—to identify an intent behind the prompt and one or more parameters of the intent. In various implementations, one or more of the parameters of the intent may include one or more of the length constraints. For example, if user 122 issues a request such as “Summarize {{article}} in three paragraphs,” the intent may be “summarize,” and parameters of the intent may include “{{article}}” and the length constraint of “in three paragraphs.”

In yet other implementations, evaluation engine 232 may leverage generative artificial intelligence to identify length constraint(s) in input prompts 208-1 to 208-N. For example, evaluation engine 232 may be configured to assemble data indicative of the input prompt (e.g., embeddings) into what will be referred to herein as an “auxiliary” input prompt. This auxiliary input prompt may include all or part of the original input prompt 208, as well as a request (e.g., in natural language) to identify length constraint(s) in the input prompt 208. For example, the auxiliary input prompt in the above example may be “find length constraints in the following input prompt: ‘Summarize {{article}} in three paragraphs’.” Evaluation engine 232 may then process the auxiliary input prompt using one or more generative models (e.g., 104) to generate what will be referred to herein as “auxiliary” generative model output. The auxiliary generative model output may be indicative of one or more of the length constraints.

However the length constraint(s) are identified, evaluation engine 232 may next evaluate the candidate training examples—e.g., the individual pairs of input prompts 208-1 to 208-N and their corresponding generative model responses 210-1 to 210-N—for compliance with one or more of the length constraints. In some implementations, evaluation engine 232 may discard—or otherwise refrain from including in curated training data 238—candidate training examples that do not have length constraint(s) and/or that have length constraint(s) that are unsatisfied. A length constraint of a candidate training example may be unsatisfied if, for instance, the candidate training example's generative model response 210 does not match the exact length constraint(s) specified in the corresponding input prompt 208. This match can be exact or fuzzy.

For an exact match, the exact number of linguistic concepts should be equal to the length constraint. For example, a generative model response of three paragraphs exactly matches a length constraint of “in three paragraphs.” For a fuzzy match, by contrast, the number of linguistic concepts needs only be within some range (e.g., margin of error, quartile, percentage) of the length constraint. This range may be user-specified, learned, and/or set automatically. For example, in some implementations, a number of linguistic concepts matches a length constraint if the number of linguistic concepts is within some percentage, e.g., of an overall length of the generative model response. Suppose user 122 requests an article be summarized in 250 words, and that the resulting generative model response is 234 words. That would constitute a 94% match, which may be sufficient if, for example, the minimum threshold for a fuzzy match were 90%. As another example, if same request generates a generative model response that is 220 words (i.e., an 88% match), that may fail a 90% threshold requirement for fuzzy matching.

Besides discarding or otherwise disregarding (collectively, “filtering”) noncompliant candidate training examples, evaluation engine 232 may also be configured to provide compliant and/or noncompliant candidate training examples to other downstream processes. These downstream processes, such as hardening engine 234 and synthesis engine 236, may take various actions to make existing candidate training examples compliant with their respective length constraints, and/or to synthesize new candidate training examples that are length constraint-compliant.

Referring back to FIG. 2, evaluation engine 232 may provide noncompliant candidate training examples 233—which may include candidate training examples that lack length constraint(s) and/or candidate training examples that have generative model responses that violate their respective length constraints—to hardening engine 234. Hardening engine 234 may process these noncompliant candidate training examples to generate compliant candidate training examples. For example, hardening engine 234 may modify the noncompliant candidate training examples 233 to generate synthetic generative model training examples 235 for which length constraint(s) are satisfied.

Hardening engine 234 may generate synthetic generative model training examples 235 in various ways. In some implementations, hardening engine 234 may alter length constraint(s) of input prompt(s) 208 of candidate training example(s) to match length features of corresponding generative model response(s) 210. This resulting match may be a fuzzy match and/or an exact match as described previously. Additionally or alternatively, hardening engine 234 may alter the generative model response(s) of the candidate generative model training example(s) to match the length constraint(s). Again, this match may be a fuzzy match or an exact match as described previously. In some such implementations, hardening engine 234 may alter the generative model response(s) 210 by processing corresponding input prompt(s) 208 using generative model(s) (e.g., 104) to generate new generative model response(s) 210, e.g., using different parameters such as a different generative model temperature, a different random seed, etc. In some cases, these new generative model responses may be evaluated once again by evaluation engine 232 to determine compliance with length constraint(s). Hardening engine 234 may provide the synthetic generative model training examples that are length constraint-compliant to curated training data 238.

In some implementations, evaluation engine 232 may provide length constraint-compliant candidate generative model training examples 237 to synthesis engine 236. Based on these length constraint-compliant candidate generative model training examples 237, synthesis engine 236 may be configured to generate new synthetic training examples 239 that may or may not be length constraint-compliant, and that if length constraint-compliant, can provide additional training data for log 238. Synthesis engine 236 may generate these new synthetic training examples in various ways. In some implementations, synthesis engine 236 may process the same input prompts 208-1 to 208-N using a generative model 241 (which may be the same as 104 or different) to generate new generative model responses. Due to the stochastic/non-deterministic nature of many generative models—e.g., due to factors such as model temperature, random seeds, etc.—these new generative model responses may be different than the original, “ground truth” generative model responses. In some implementations, evaluation engine 232 may determine whether the new synthetic training examples 239 are length constraint-compliant, and if so, they can be added to curated training data 238.

In various implementations, curated training data 238 may be used by a training engine 240 to train and/or fine-tune one or more generative models 104. For example, training engine 240 may process input prompts of curated training data 238 using one or more generative model(s) 104 to generate responses. These responses may then be compared with responses of the curated data to determine error, which can be used by training engine 240 to train generative model(s) 104, e.g., using techniques such as cross entropy loss, gradient descent, back propagation, etc.

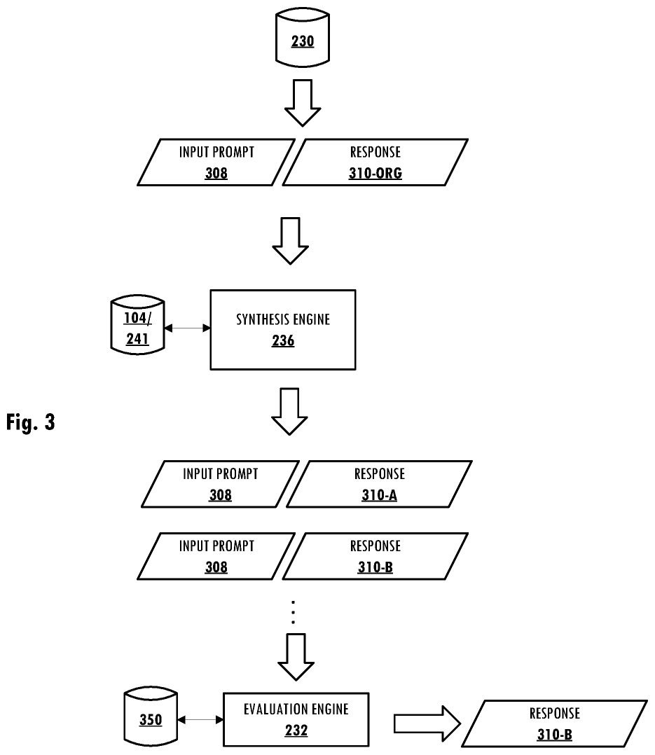

In some implementations, techniques such as reinforcement learning may be used to efficiently generate quality training data, so that training and fine-tuning can also be performed efficiently. FIG. 3 schematically depicts an example of how synthesis engine 236 may be used as part of this process.

Starting at top, an example log entry may be obtained from log 230 of candidate training examples (which may or may not have length constraints and/or be length constraint-compliant). Each example log entry may include an input prompt 308 and a corresponding generative model response, 310-ORG (“ORG” stands for an “original” generative model response that has already been generated).

Based on input prompt 308, synthesis engine 236 may generate what will be referred to herein as a “generative model interaction set.” A generative model interaction set may include, for instance, a single input prompt 308 and a plurality of candidate generative model responses, 310-A, 310-B, Evaluation engine 232 may evaluate the candidate generative model responses 310-A, 310-B, . . . using one or more of the techniques described previously in relation to FIG. 2, to determine length constraint compliance with the input prompt 308 used to generate them. Additionally or alternatively, evaluation engine 232 may process the candidate generative model responses 310-A, 310-B, . . . using a reward model or function 350 that is trained or otherwise usable to assign quality metrics such as length constraint compliance to the candidate generative model responses 310-A, 310-B, . . . . Based on these quality metrics, evaluation engine 232 may select, to be paired with the input prompt 308, the candidate generative model response 310-B that most closely complies with the length constraint(s) of input prompt 308 for inclusion as a generative model training example. As shown in FIG. 2, training engine 240 may then train generative model(s) using the selected generative model training example (308/310-B in FIG. 3).

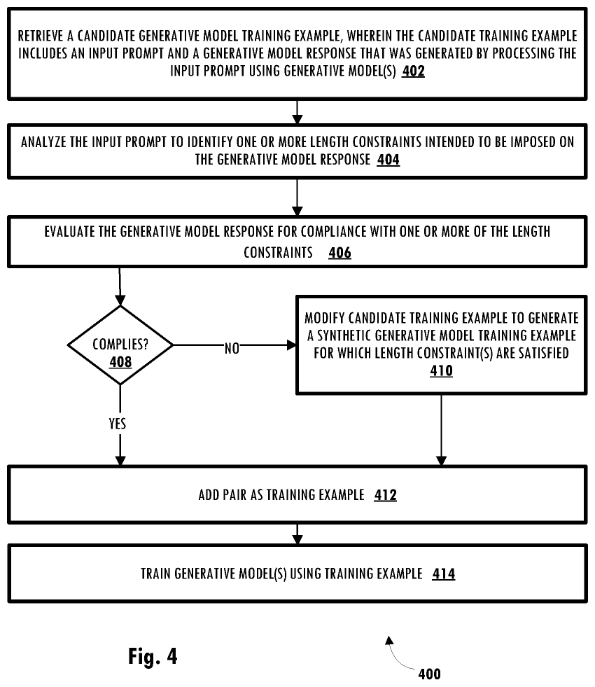

Referring now to FIG. 4, an example method 400 of practicing selected aspects of the present disclosure is described. For convenience, the operations of the flowchart are described with reference to a system that performs the operations. This system may include various components of various computer systems, including those depicted in FIGS. 1-2. Moreover, while operations of method 400 are shown in a particular order, this is not meant to be limiting. One or more operations may be reordered, omitted or added.

At block 402, the system, e.g., by way of evaluation engine 232, may retrieve a candidate generative model training example. In various implementations, the candidate training example may include an input prompt (e.g., 208) and a generative model response (e.g., 210) that was generated by processing the input prompt using one or more generative models (e.g., 104).

At block 404, the system, e.g., by way of evaluation engine 232, may analyze the input prompt (e.g., 208) to identify one or more length constraints intended to be imposed on the generative model response. As noted previously, evaluation engine 232 may detect length constraints in various ways, such as heuristically/programmatically, by using NLP to identify an intent and associated parameters, and/or by assembling the input prompt into an auxiliary input prompt along with a command to identify length constraints.

However, the length constraints are identified, at block 406, evaluation engine 232 may evaluate the generative model response for compliance with one or more of the length constraints. If the answer at block 408 is no, then method 400 proceeds to block 410, at which point the candidate training example can be modified, e.g., by hardening engine 234, to generate a synthetic generative model training example for which one or more length constraints are satisfied. This can include modifying length constraint(s) of the input prompt to match (exact or fuzzy) length features (e.g., number of words, characters, sentences, paragraphs, bullet points, table properties, etc.) of the generative model response, or vice versa. In many implementations, this may be performed automatically, e.g., programmatically and/or using machine learning. In other implementations, human curators may do the modifying.

Whether the answer at block 408 is yes (candidate training example is length constraint-compliant) or whether the modification is performed at block 410, method 400 may proceed to block 412. At block 412, the system, e.g., by way of evaluation engine 232 or training engine 240, may add the pair of input prompt/generative model response as a training example. AT block 414, the system, e.g., by way of training engine 240, may train one or more of the generative models (e.g., 140) using the synthetic generative model training example(s).

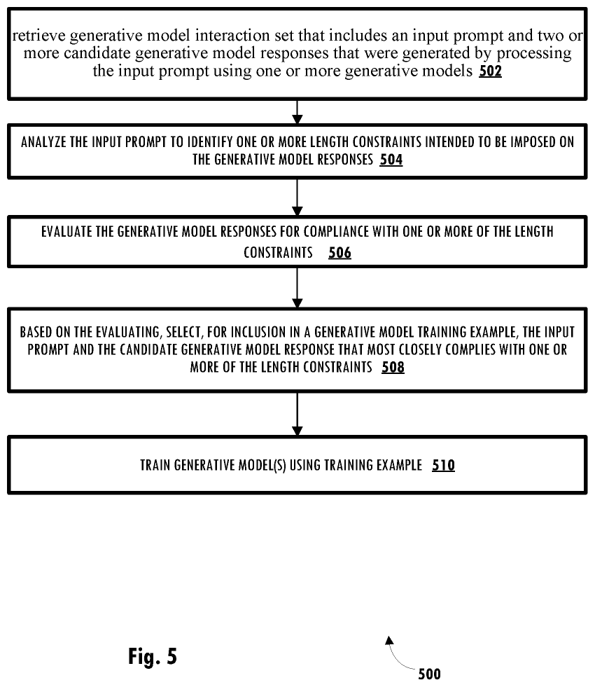

Referring now to FIG. 5, an example method 500 of practicing selected aspects of the present disclosure is described. For convenience, the operations of the flowchart are described with reference to a system that performs the operations. This system may include various components of various computer systems, including those depicted in FIG. 1. Moreover, while operations of method 500 are shown in a particular order, this is not meant to be limiting. One or more operations may be reordered, omitted or added.

At block 502, the system, e.g., by way of evaluation engine 232, may retrieve a generative model interaction set. Such a generative model interaction set may include, for instance, an input prompt and two or more candidate generative model responses that were generated by processing the input prompt using one or more generative models. An example generative model interaction set was depicted in FIG. 3 that included input prompt 308 and candidate generative model responses 310-A, 310-B, . . .

At block 504, the system, e.g., by way of evaluation engine 232, may analyze the input prompt to identify one or more length constraints intended to be imposed on the generative model responses, similar to block 404 of method 400. At block 506, the system, e.g., by way of evaluation engine 232, may evaluate the candidate generative model responses for compliance with one or more of the length constraints, similar to block 406 of method 400.

Based on the evaluating of block 506, at block 508, the system, e.g., by way of evaluation engine 232, may select, for inclusion in a generative model training example, the input prompt and the candidate generative model response that most closely complies with one or more of the length constraints. Similar to block 414 of method 400, at block 510, the system, e.g., by way of training engine 240, may train one or more of the generative models using the generative model training example.

FIG. 6 is a block diagram of an example computer system 610. Computer system 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computer system 610. Network interface subsystem 616 provides an interface to outside networks and is coupled to corresponding interface devices in other computer systems.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computer system 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 610 to the user or to another machine or computer system.

Storage subsystem 624 stores programming and data constructs that provide the functionality of some or all of the modules described herein. For example, the storage subsystem 624 may include the logic to perform selected aspects of methods 400 and/or 500, and/or to implement one or more aspects of the various components depicted in FIGS. 1 and/or 2. Memory 625 used in the storage subsystem 624 can include a number of memories including a main random-access memory (RAM) 630 for storage of instructions and data during program execution and a read only memory (ROM) 632 in which fixed instructions are stored. A file storage subsystem 626 can provide persistent storage for program and data files, and may include a hard disk drive, a CD-ROM drive, an optical drive, or removable media cartridges. Modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computer system 610 communicate with each other as intended. Although bus subsystem 612 is shown schematically as a single bus, alternative implementations of the bus subsystem may use multiple buses.

Computer system 610 can be of varying types including a workstation, server, computing cluster, blade server, server farm, smart phone, smart watch, smart glasses, set top box, tablet computer, laptop, or any other data processing system or computing device. Due to the ever-changing nature of computers and networks, the description of computer system 610 depicted in FIG. 6 is intended only as a specific example for purposes of illustrating some implementations. Many other configurations of computer system 610 are possible having more or fewer components than the computer system depicted in FIG. 6.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors and comprising:
retrieving a candidate generative model training example, wherein the candidate generative model training example includes an input prompt and a generative model response that was generated by processing the input prompt using one or more generative models;
analyzing the input prompt to identify one or more length constraints intended to be imposed on the generative model response;
evaluating the generative model response for compliance with one or more of the length constraints;
based on a determination that the generative model response fails to comply with one or more of the length constraints, modifying the candidate generative model training example to generate a synthetic generative model training example for which one or more length constraints are satisfied; and
training one or more of the generative models using the synthetic generative model training example.

2. The method of claim 1, wherein the modifying comprises altering one or more of the length constraints of the input prompt to match one or more length features of the generative model response.

3. The method of claim 2, wherein the match comprises a fuzzy match.

4. The method of claim 1, wherein the modifying comprises altering the generative model response to match one or more of the length constraints.

5. The method of claim 4, wherein the match comprises a fuzzy match.

6. The method of claim 4, wherein the altering comprises processing the input prompt using one or more of the generative models to generate a new generative model response.

7. The method of claim 1, wherein analyzing the input prompt comprises parsing the input prompt to detect one or more linguistic concepts and numeric modifiers of the one or more linguistic concepts.

8. The method of claim 7, wherein the one or more linguistic concepts include a sentence, and the one or more numeric modifiers include a number of requested sentences.

9. The method of claim 7, wherein the one or more linguistic concepts include a word, and the one or more numeric modifiers include a number of requested words.

10. The method of claim 7, wherein the one or more linguistic concepts include a paragraph, and the one or more numeric modifiers include a number of requested paragraphs.

11. The method of claim 1, wherein analyzing the input prompt comprises performing natural language processing (NLP) on the input prompt to identify an intent behind the prompt and one or more parameters of the intent, wherein one or more of the parameters of the intent include one or more of the length constraints.

12. The method of claim 1, wherein analyzing the input prompt comprises:
assembling data indicative of the input prompt into an auxiliary input prompt;
assembling, into the auxiliary prompt, data indicative of a natural language request to identify the one or more length constraints in the input prompt; and
processing the auxiliary input prompt using one or more of the generative models to generate auxiliary generative model output indicative of one or more of the length constraints.

13. The method of claim 1, wherein one or more of the generative models comprises a large language model (LLM).

14. A method implemented using one or more processors and comprising:
retrieving a generative model interaction set that includes an input prompt and two or more candidate generative model responses that were generated by processing the input prompt using one or more generative models;
analyzing the input prompt to identify one or more length constraints intended to be imposed on the generative model responses;
evaluating the candidate generative model responses for compliance with one or more of the length constraints;
based on the evaluating, selecting, for inclusion in a generative model training example, the input prompt and the candidate generative model response that most closely complies with one or more of the length constraints; and
training one or more of the generative models using the generative model training example.

15. The method of claim 14, wherein the two or more candidate generative model responses comprise first and second candidate generative model responses, generated using the same generative model, which are different from each other.

16. The method of claim 15, wherein the first and second candidate generative model responses differ from each other due to a temperature parameter used in association with the generative model.

17. The method of claim 14, wherein the two or more candidate generative model responses comprise a first candidate generative model response generated using a first generative model and a second candidate generative model response generated using a second generative model that is different from the first generative model.

18. The method of claim 17, wherein the second generative model comprises fewer parameters than the first generative model.

19. The method of claim 14, wherein the selecting is performed using a trained reward function.

20. At least one non-transitory computer-readable medium comprising instructions that, in response to execution by one or more processors, cause the one or more processors to:
retrieve a candidate generative model training example, wherein the candidate generative model training example includes an input prompt and a generative model response that was generated by processing the input prompt using one or more generative models;
analyze the input prompt to identify one or more length constraints intended to be imposed on the generative model response;
evaluate the generative model response for compliance with one or more of the length constraints;
based on a determination that the generative model response fails to comply with one or more of the length constraints, modify the candidate generative model training example to generate a synthetic generative model training example for which one or more length constraints are satisfied; and
train one or more of the generative models using the synthetic generative model training example.
